(19) United States
(12) Patent Application Publication
(10) Pub. No.: US 2012/0103940 A1
(43) Pub. Date: May 3, 2012

(54) GAS BLAST CIRCUIT BREAKER WITH MAKING RESISTANCE CONTACT AND ITS MAKING AND BREAKING METHOD

(75) Inventors: Yoshiaki Ohda, Kanagawa-ken (JP); Hirokazu Takagi, Kanagawa-ken (JP)

(73) Assignee: KABUSHIKI KAISHA TOSHIBA, Tokyo (JP)

(21) Appl. No.: 13/381,131

(22) PCT Filed: Jun. 18, 2010
(86) PCT No.: PCT/JP10/04075

§ 371 Date: Dec. 28, 2011

(30) Foreign Application Priority Data
Jun. 29, 2009 (JP) 2009-153786

(51) Int. Cl. H01H 33/02

(52) U.S. Cl. 218/50

(57) ABSTRACT

A gas blast circuit breaker with a making resistance contact includes a first movable electrode in which a first arc electrode and a first main electrode in a concentric state are arranged, a second movable electrode in which a second arc electrode and a second main electrode in a concentric state are arranged and which is arranged to face the first movable electrode in the longitudinal direction, a drive device to drive the two movable electrodes to contact with or separate from each other, a conductive support member to slidably support the second main electrode, a making resistive element to slidably support an end portion of the second arc electrode, and a making resistance contact having a fixed making resistance contact fixed to the conductive support member around the second arc electrode and a movable making resistance contact supported by the second arc electrode.

### CROSS-REFERENCE TO RELATED APPLICATION

This application is a continuation application of International Application No. PCT/JP2010/004075 filed on Jun. 18, 2010, which is based upon and claims the benefit of priority from the prior Japanese Patent Application No. 2009-153786, filed on Jun. 29, 2009, the entire contents of which are incorporated herein by reference.

### FIELD

Embodiments described herein relate generally to a gas blast circuit breaker with a making resistance contact and its making and breaking method.

### BACKGROUND

As a result that a transmission system with a large capacity has been used, breaking capacities of circuit breakers used in substations and switching stations increase, and high reliability thereof is required. In order to increase the reliability of a circuit breaker, it is important to reduce the number of components and simplify its structure. Incidentally, in a circuit breaker for a line use in a large capacity system such as a 550 kV system, a making resistance system is employed so as to suppress making overvoltage at the time of making. In this system, a making resistance contact having a making resistor in parallel with a main contact of a circuit breaker is provided, the making resistance contact is closed at the time of making, and the main contact is closed in the state in which the making overvoltage is suppressed by the making resistor. In this system, it is necessary that at the time of opening contact, the making resistance contact is firstly separated and then the main contact is opened.

A gas blast circuit breaker with a making resistance contact like this is disclosed in Patent Document 1 (refer to Japanese Patent Application Publication No. Toku Kai Hei 3-274626) as a first conventional example. This circuit breaker has a structure in which a main contact of the circuit breaker and a making resistance contact are arranged in parallel, and a movable portion of the making resistance contact is connected to a movable portion of the main contact with a coupling lever, and the movable portion of the main contact is driven by an operating mechanism via an insulating rod. Examples having the same structure as this gas blast circuit breaker are disclosed also in Patent Documents 2, 3 (refer to Japanese Patent Application Publication No. Toku Kai Hei 11-144576 and Japanese Patent No. 2989653).

On the other hand, as a second conventional example, a circuit breaker called a double motion system in which opposing electrodes of a main contact are simultaneously moved to open the contact so as to make the opening speed of the contact fast is disclosed in Patent Document 4 (refer to Japanese Patent Application Publication No. Toku Kai Hei 2-297826). In this circuit breaker, making resistance contacts are arranged to surround a main contact of the circuit breaker, and each of movable portions of the making resistance contacts is coupled to each of movable portions of the main contact.

In the first conventional example of the above-described gas blast circuit breaker with a making resistance contact, at the time of making and breaking, assuming an axial line of the insulating rod which moves back and forth as a movement axis, since the operating force of the operating mechanism linearly acts on the movable member including the main contact arranged in the movement axis direction, the movable member displaces little in the direction other than the movement axis. But, since the making resistance contact is arranged apart from the movement axis, eccentric load due to inertial force is generated for the main contact, and thereby bending moment acts on the coupling lever. Abnormal vibration is generated in the direction other than the movement axis by the effect of this bending moment, causing the strengths of various members to be decreased.

In addition, since the making resistance contact is arranged in parallel outside the main contact, the width dimension of the contact portion becomes large, and the size of the vessel to house it also becomes large. For this reason, in case that a gas blast circuit breaker without a making resistance contact is composed by a puffer type which blows insulating gas to the arc, the weight of the movable portion becomes light, and if the same operating mechanism as in the circuit breaker with the making resistance contact, difference may be caused in the property of opening and making contact, such as, a speed and an operating time. In particular, in the spring operating mechanism which has a small operating force and is subject to the effect of the weight of the movable portion, since difference is generated in the property of opening and making contact, it is necessary to prepare an operating mechanism with different drive energy.

Furthermore, the making resistance contact is of a bat contact system, and since one of the two facing contacts makes contact with the other contact while coming close to the other contact at a high speed, a large impact force is generated. For this reason, it is necessary to form the making resistance contact to be solid, and this plays a role in increasing the weight of the gas blast circuit breaker.

In the second conventional example, the making resistance contacts are arranged to surround the main contact, and since the making resistance contacts are arranged as well apart from the movement axis that is the axis line of the operating rod which moves back and forth, the contact portion becomes large in the same manner as in the first conventional example, and in addition, the point that the size of the vessel to house it becomes large and the point that the making resistance contact is of a bat contact type are the same as in the first conventional example.

### BRIEF DESCRIPTION OF THE DRAWINGS

FIG. 1 is a sectional view showing a gas blast circuit breaker with a making resistance contact in the broken state according to a first embodiment;

FIG. 2 is a sectional view showing the gas blast circuit breaker during the making operation;

FIG. 3 is a sectional view showing the gas blast circuit breaker in the closed state;

FIG. 4 is a sectional view showing the gas blast circuit breaker during the breaking operation;

FIG. 5 is a sectional view showing a gas blast circuit breaker with a making resistance contact in the broken state according to a second embodiment;

FIG. 6 is a sectional view showing the gas blast circuit breaker during the making operation;

FIG. 7 is a sectional view showing the gas blast circuit breaker in the closed state; and

FIG. 8 is a sectional view showing the gas blast circuit breaker during the breaking operation.

### DETAILED DESCRIPTION

According to one embodiment, a gas blast circuit breaker with a making resistance contact includes a first movable electrode in which a first arc electrode and a first main electrode in a concentric state are arranged, a second movable electrode in which a second arc electrode and a second main electrode in a concentric state are arranged and which is arranged to face the first movable electrode in the longitudinal direction, a drive device to drive so that the two movable electrodes contact with or separate from each other, a conductive support member to slidably support the second main electrode, a making resistive element to slidably support an end portion of the second arc electrode, and a making resistance contact having a fixed making resistance contact fixed to the conductive support member around the second arc electrode and a movable making resistance contact supported by the second arc electrode. At the time of making, the movable making resistance contact contacts with the fixed making resistance contact after the first arc electrode and the second arc electrode have contacted, and at the time of breaking, the making resistance contact is separated after the first arc electrode and the second arc electrode have been separated.

According to another embodiment, a making and breaking method of a gas blast circuit breaker with a making resistance contact is a making and breaking method of a gas blast circuit breaker with a making resistance contact including a first movable electrode in which a first arc electrode and a first main electrode in a concentric state are arranged, a second movable electrode in which a second arc electrode and a second main electrode in a concentric state are arranged and which is arranged to face the first movable electrode in the longitudinal direction, a drive device to drive so that the two movable electrodes contact with or separate from each other, and a making resistance contact having a fixed making resistance contact fixed to a conductive support member and a movable making resistance contact supported by the second arc electrode. At the time of making, when the first arc electrode and the second arc electrode are driven by the drive device and contact with each other, current flows from the second arc electrode to a making resistive element, and then when the movable making resistance contact contacts with the fixed making resistance contact, current flows from the second arc electrode to the conductive support member via the making resistance contact. And at the time of breaking, when the first arc electrode and the second arc electrode are driven by the drive device and are separated, arc current which is generated at this time is flown to the conductive support member via the making resistance contact, and then the movable making resistance contact is separated from the fixed making resistance contact.

Hereinafter, embodiments of gas blast circuit breakers with a making resistance contact will be described with reference to the drawings. Each of the embodiments is applied to a puffer type gas blast circuit breaker of the same double motion system as the above-described second conventional example.

### First Embodiment

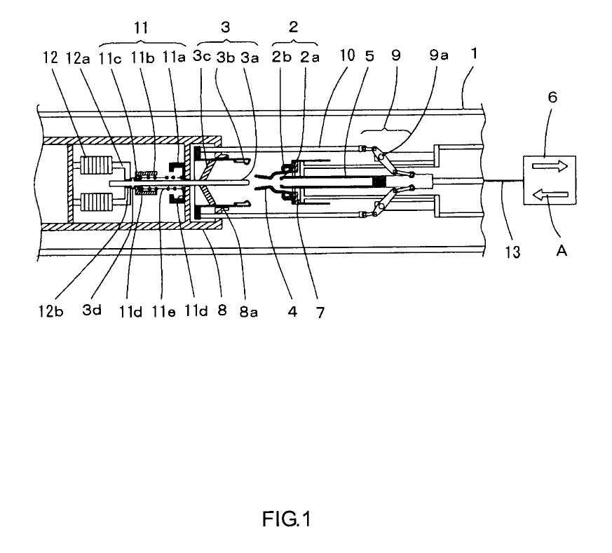

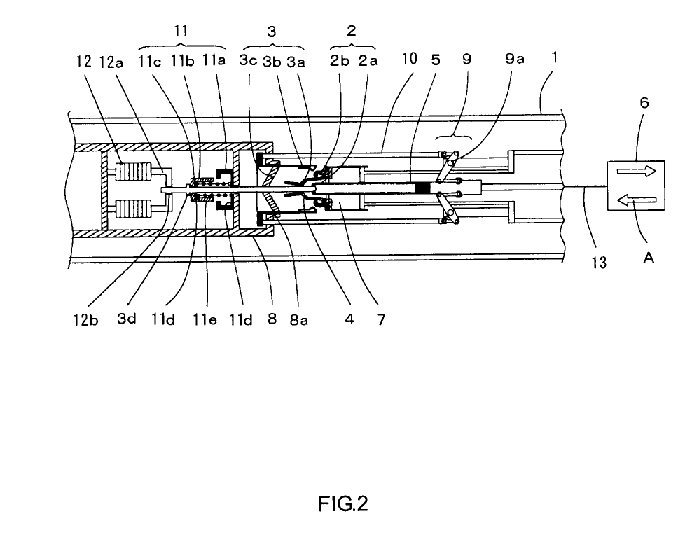

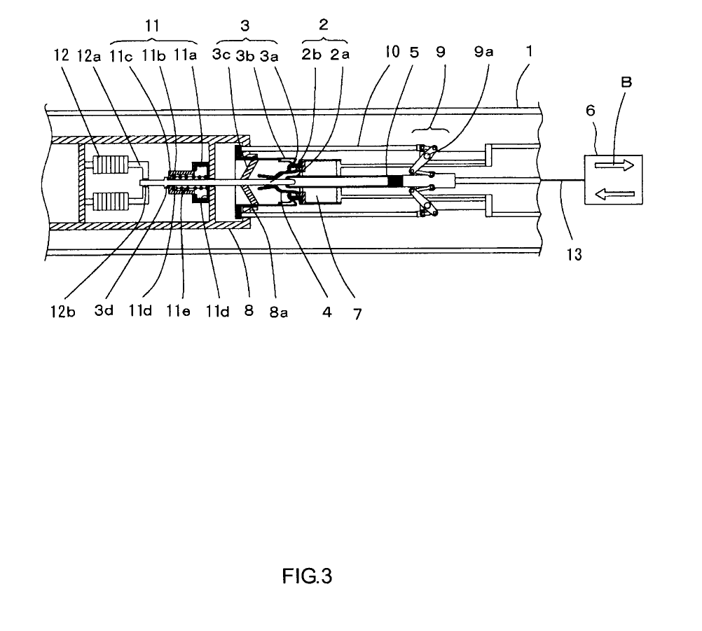

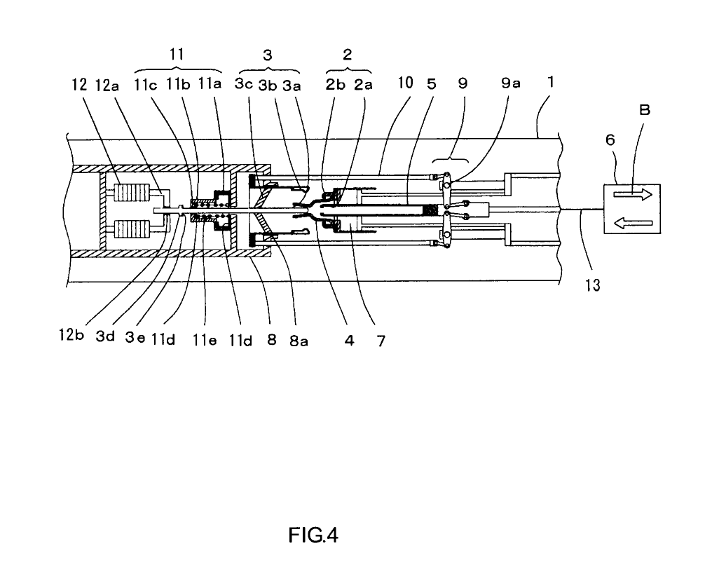

A gas blast circuit breaker with a making resistance contact according to a first embodiment will be described using FIG. 1-FIG. 4. FIG. 1 is a sectional view showing the gas blast circuit breaker in the broken state, FIG. 2 is a view showing the gas blast circuit breaker during the making operation, FIG. 3 is a view showing the gas blast circuit breaker in the closed state, and FIG. 4 is a view showing the gas blast circuit breaker during the breaking operation.

In FIG. 1, the gas blast circuit breaker with a making resistance contact according to the present embodiment is constructed such that insulating gas is hermetically sealed in a vessel 1 in the same manner as in the conventional technology, and a first movable electrode 2 and a second movable electrode 3 which are separable and compose a main contact are arranged in the longitudinal direction to face each other are housed in the vessel 1. The first movable electrode 2 is composed of a tubular first arc electrode 2a and a first main electrode 2b in a concentric state, and an insulating nozzle 4 and an operating rod 5 are respectively fixed to it. An operating mechanism 6 is coupled to the operating rod 5. An axis line along which the operating rod 5 moves back and forth at the central portion in the vessel 1 is determined as a movement axis 13. A pressure chamber 7 so as to pressurize the insulating gas is arranged at the first movable electrode 2, and the insulating gas in the pressure chamber 7 jets out from between the first arc electrode 2a and the insulating nozzle 4.

The second movable electrode 3 is composed of a second arc electrode 3a and a second main electrode 3b in a concentric state. The second arc electrode 3a is fixed to a second main electrode 3b with an insulating support member 3c and is electrically insulated from it. The second main electrode 3b is slidably supported to a conductive support member 8 via a slidable contact shoe 8a. The second arc electrode 3a is rod-shaped and the first arc electrode 2a is tubular, and they compose a slide contact type contact.

A link mechanism 9 with a support point 9a which makes the direction of the driving force to be inverted is coupled to the operating rod 5 at the operating mechanism 6 side, and one end of an insulating rod 10 is firmly fixed to the link mechanism 9 and the second movable electrode 3 is firmly fixed on the other end thereof. The first movable electrode 2 and the second movable electrode 3 are driven in the reverse direction by a drive device including the operating mechanism 6, the operating rod 5, the link mechanism 9 and the insulating rod 10 so that they are contacted and separated.

A making resistance contact 11 is arranged inside the tubular conductive support member 8 and is composed of a fixed making resistance contact 11a and a movable making resistance contact 11b. The fixed making resistance contact 11a is arranged around the second arc electrode 3a and is firmly fixed to the conductive support member 8, and the movable making resistance contact 11b is slidably supported to the same axis as that of the second arc electrode 3a in the electrically conductive manner via a slidable contact shoe 11c. A protruding portion 3d fixed to the second arc electrode 3a can contact with and separate from the movable making resistance contact 11b. A return spring 11e is arranged between the fixed making resistance contact 11a and the movable making resistance contact 11b via an insulating plate 11d. The movable making resistance contact 11b is biased by the return spring 11e in the direction to separate from the fixed making resistance contact 11a, and is in a construction to be pressed to the protruding portion 3d.

One end of a making resistive element 12 is firmly fixed to the conductive support member 8, and the other end thereof composes a making resistive element support member 12a. The end portion of the second arc electrode 3a is slidably supported to the making resistive element support member 8 via a sliding contact shoe 12b in the electrically conductive manner. The second arc electrode 3a penetrates through an opening portion at the center of the tubular shape of the conductive support member 8, and is insulated from it.

(Making Operation)

In the present embodiment constructed like this, a making operation from the broken state shown in FIG. 1 to the closed state shown in FIG. 3 through the state during the making operation shown in FIG. 2 will be described.

In the broken state shown in FIG. 1, when an external command is inputted to the operating mechanism 6, the operating rod 5 and the movable electrode 2 start moving along the movement axis 13 in the direction of an arrow A by an operating force. The operating force is transmitted to the link mechanism 9, and drives the insulating rod 10 in the direction reverse to the arrow A assuming the support point 9a as a rotation center. As a result, the second movable electrode 3 and the movable making resistance contact 11b move in the direction reverse to the arrow A. The movable making resistance contact 11b moves along with the second arc electrode 3a against the spring force of the return spring 11e.

FIG. 2 shows the state in which the first arc electrode 2a contacts with the second arc electrode 3a in the state during the making operation. In this state, since the first main electrode 2b and the second main electrode 3b are not contacted, and the movable making resistance contact 11b and the fixed making resistance contact 11a are not contacted, current flows from the first arc electrode 2a through the second arc electrode 3a, and from the sliding contact shoe 12b to the making resistive element 12 via the making resistive element support member 12a. If the making operation further progresses from this state, the state gets into the closed state shown in FIG. 3.

In this state, the movable making resistance contact 11b contacts the fixed making resistance contact 11a, and also the first main electrode 2b contacts the second main electrode 3b. As a result, current flows from the first arc electrode 2a, the second arc electrode 3a, via the slidable contact shoe 11c, the movable making resistance contact 11b and the fixed making resistance contact 11a to the conductive support member 8, and in addition, current flows from the first main electrode 2b, the second main electrode 3b via the slidable contact shoe 8a to the conductive support member 8, and current does not flow into the making resistive element 12.

(Breaking Operation)

Next, the breaking operation from the closed stated shown in FIG. 3 to the broken state shown in FIG. 1 through the state during the breaking operation shown in FIG. 4 will be described.

In the closed state shown in FIG. 3, when an external command is inputted to the operating mechanism 6, the operating rod 5 and the first movable electrode 2 start moving along the movement axis 13 in the direction of an arrow B by an operating force. The operating force is transmitted to the link mechanism 9, and drives the insulating rod 10 in the direction reverse to the arrow B assuming the support point 9a as the rotation center. As a result, the second movable electrode 3 moves in the direction reverse to the arrow B.

During the breaking operation shown in FIG. 4, the state that the first movable electrode 2 and the second movable electrode 3 are separated is shown. By the movement of the second arc electrode 3a, the movable making resistance contact 11b is driven to the making resistive element 12 side by the return spring 11e, and thereby is separated from the fixed making resistance contact 11a. On this occasion, in order that the making resistance contact 11 is separated after the separation of the first arc electrode 2a from the second arc electrode 3a, the movable making resistance contact 11b is followed later than the movement of the second arc electrode 3a. That is, the spring force (constant of spring) of the return spring 11e is set to a proper value so that the movable making resistance contact 11b is not separated from during the breaking operation, but separated from the fixed making resistance contact 11a after the breaking operation is finished. As a result, at the time of breaking, the arc current which is generated between the first arc electrode 2e and the second arc electrode 3a does not flow into the making resistive element 12, but flows from the second arc electrode 3a to the conductive support member 8 via the slidable contact shoe 11c, the movable making resistance contact 11b and the fixed making resistance contact 11a.

According to the present embodiment, since the first movable electrode 2, the second movable electrode 3 and the making resistance contact 11 are arranged on the movement axis 13 in a straight line, and the making resistance contact 11 is arranged at the second movable electrode 3 side, the diameter that is the width of the contact portion can be made small and the size of the vessel can also be made small. In addition, since there is not any contact member having mass which is biased against the movement axis 13, abnormal vibration in the direction other than the movement axis 13 is hardly generated at the time of the making and breaking operation, the effect upon the part strength is made small, and thereby the reliability is improved.

Since the making resistance contact 11 is not provided integrally with the first movable electrode 2 and the second movable electrode 3 and is not arranged around them, and its mass can be made smaller than those of the other electrodes, large change is not given in the making operation property. Since the movable making resistance contact 11b which is made light weighted collides against the fixed making resistance contact 11a at a slow speed that is about half the making speed, for example, it is constructed so that large impact force is not generated. Since, at the time of making, to close the making resistor is performed by making contact between the arc electrodes of the movable electrodes, and in addition, its contacting is enabled by making contact between the slide contact type contacts, large impact force is not generated.

Furthermore, in the case of a gas blast circuit breaker without the making resistance contact 11, since the weight of the movable portion becomes about the same as that with the making resistance contact, the difference in the contact opening property is not generated. As a result, the same operating mechanism having the equal drive energy can be applied.

### Second Embodiment

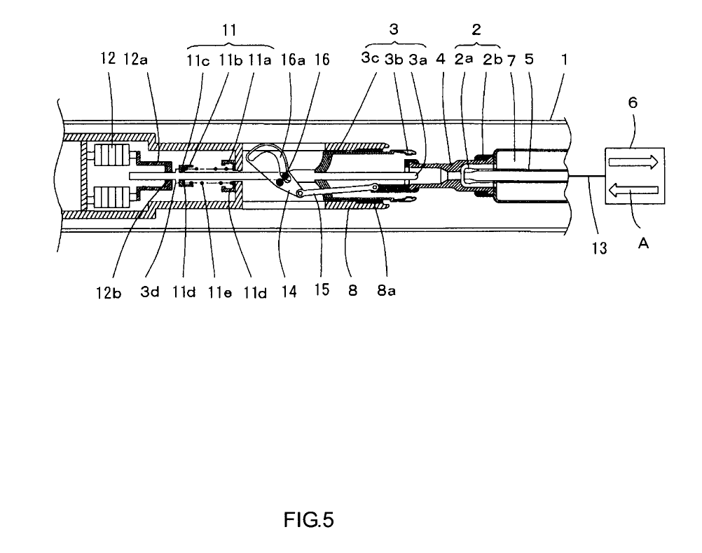

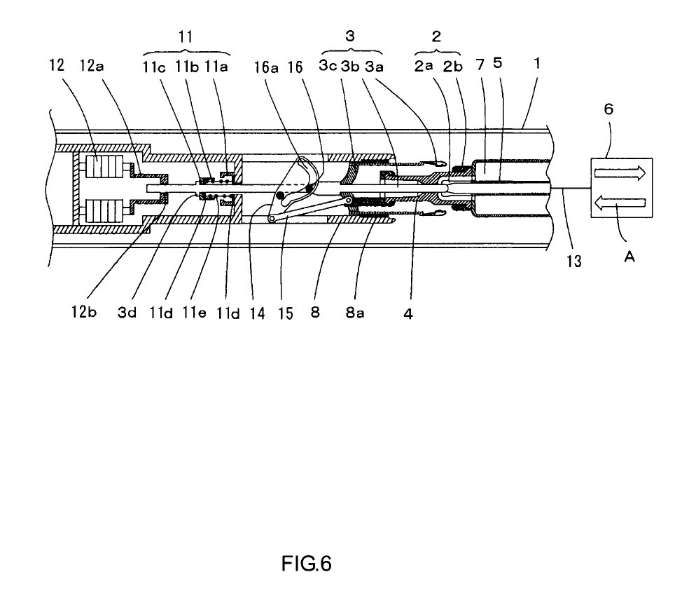

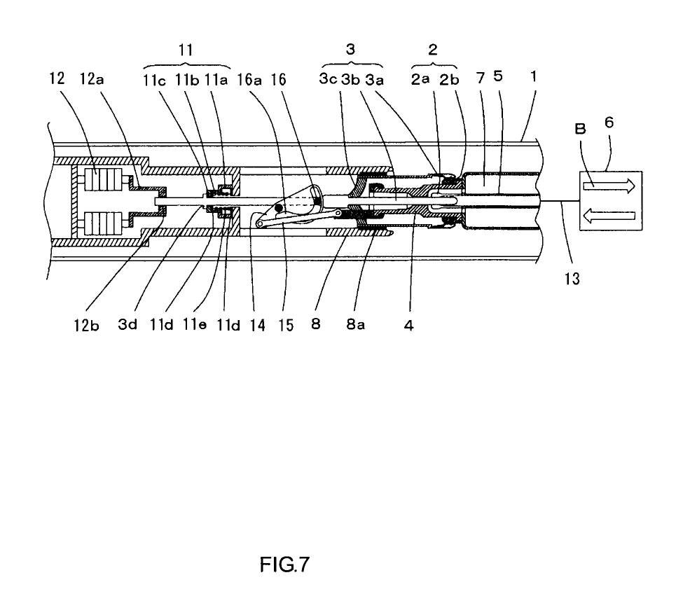

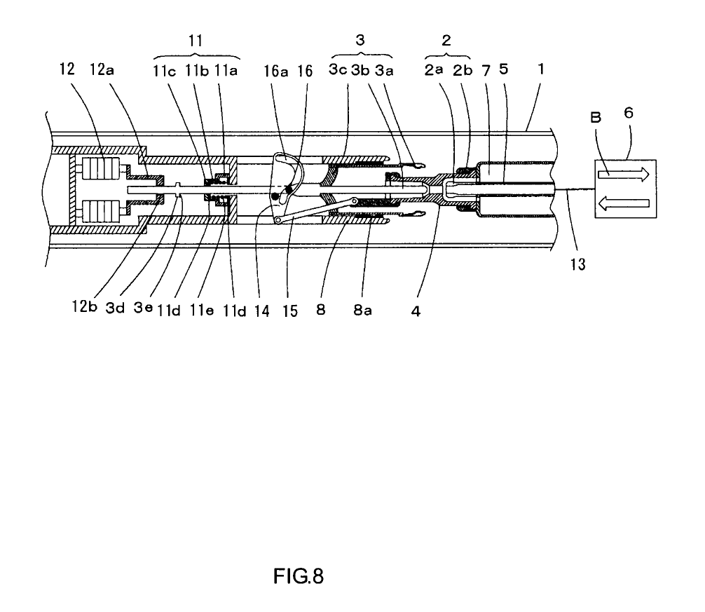

Next, a puffer type gas blast circuit breaker with a making resistance contact according to a second embodiment will be described using FIG. 5-FIG. 8. The common symbols are given to the same or similar portions as in the first embodiment, and the duplicated description will be omitted. FIG. 5 is a sectional view showing a puffer type gas blast circuit breaker with a making resistance contact according to the present embodiment in the broken state, FIG. 6 is a sectional view showing the gas blast circuit breaker during the making operation, FIG. 7 is a sectional view showing the gas blast circuit breaker in the closed state, and FIG. 8 is a sectional view showing the gas blast circuit breaker during the breaking operation.

In FIG. 5, a grooved cam 14 which drives the second movable electrode 3 facing the first movable electrode 2 in the relatively separating direction is arranged at the second movable electrode 3 side. A construction is used in which the grooved cam 14 is coupled to a coupling rod 15 extending from the insulating nozzle 4, a cam roller 16 provided at the second movable electrode 3 is engaged with a groove 16a of the grooved cam 16 and slides, and thereby the second movable electrode 3 is moved in the direction opposite to the first movable electrode 2.

In the first embodiment, the second movable electrode 3 is driven in the direction reverse to the first movable electrode 2 by the link mechanism 9 and the insulating rod 10, but in the present embodiment, the second movable electrode 3 is driven in the direction reverse to the first movable electrode 2 by the coupling rod 15 and the grooved cam 14.

Since the making operation and the breaking operation are performed in the approximately same manner as in the first embodiment and can be reasoned by analogy from FIG. 5-FIG. 8, the description thereof will be omitted. In the case of being constructed as described above, the same operation and effect as in the above-described first embodiment can be obtained.

### Other Embodiments

In the above-described embodiments, a compression coil spring is used as the return spring 11e, for example, but other elastic body element such as a disc spring and so on can also be used. The insulating plates 11d are used at the both ends of the return spring 11e so as to have electrical insulating function, but the insulating plate 11d may be arranged only at one side.

In addition, the return spring 11e is not necessary formed by a metal, but one which is formed by an insulator such as ceramic can be used, and in this case the insulating plate 11d can be omitted. An impact absorbing member 3e (shown in FIGS. 4, 8) can be arranged at the protrusion portion 3d so as to absorb the impact force generated from the collision of the protrusion portion 3d and the movable making resistance contact 11b, by the spring force of the return spring 11e at the breaking operation.

In drive device of the first and second embodiments, the link mechanism 9 and the grooved cam mechanism have been used, but the making resistance contact 11 which is proposed in the present embodiments can be applied to a gas blast circuit breaker using other drive means which is different from these mechanisms.

According to the present embodiments, since the making resistance contact is arranged on the movement axis for the two movable electrodes and at the side of the second movable electrode which is opposite to the first movable electrode, the width of the contact portion becomes small, and the size of the vessel can be made small. Since there is not any contact member having mass which is biased against the movement axis, abnormal vibration is hardly generated at the time of operating, and the reliability of the making and breaking operation is improved. In addition, the movable portion of the making resistance contact is light and its moving speed is low, and to close the making resistor is performed by making contact between the arc electrodes of the movable electrodes, so that large impact force is not generated. In the case of a gas blast circuit breaker without a making resistance contact, since the weight of the movable portion becomes approximately the same weight, the contact opening property does not change. As a result, the same operating mechanism having the equal drive energy can be applied.

While certain embodiments have been described, those embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A gas blast circuit breaker with a making resistance contact, comprising:
a first movable electrode in which a first arc electrode and a first main electrode in a concentric state are arranged;
a second movable electrode in which a second arc electrode and a second main electrode in a concentric state are arranged and which is arranged to face the first movable electrode in the longitudinal direction;
a drive device to drive so that the two movable electrodes contact with or separate from each other;
a conductive support member to slidably support the second main electrode;
a making resistive element to slidably support an end portion of the second arc electrode; and
a making resistance contact having a fixed making resistance contact fixed to the conductive support member around the second arc electrode and a movable making resistance contact supported by the second arc electrode;
wherein at the time of making, the movable making resistance contact contacts with the fixed making resistance contact after the first arc electrode and the second arc electrode have contacted, and at the time of breaking, the making resistance contact is separated after the first arc electrode and the second arc electrode have been separated.

2. The gas blast circuit breaker with a making resistance contact as recited in claim 1, wherein:
at the time of breaking, the movable making resistance contact is biased by a return spring in the direction to separate from the fixed making resistance contact.

3. The gas blast circuit breaker with a making resistance contact as recited in claim 1, wherein:
the drive device has a link mechanism to make the second movable electrode to be moved in the direction reverse to the movement of the first movable electrode by an operating rod.

4. The gas blast circuit breaker with a making resistance contact as recited in claim 1, wherein:
the drive device has a grooved cam mechanism to make the second movable electrode to be moved in the direction reverse to the movement of the first movable electrode by an operating rod.

5. In a making and breaking method of a gas blast circuit breaker with a making resistance contact comprising a first movable electrode in which a first arc electrode and a first main electrode in a concentric state are arranged, a second movable electrode in which a second arc electrode and a second main electrode in a concentric state are arranged and which is arranged to face the first movable electrode in the longitudinal direction, a drive device to drive so that the two movable electrodes contact with or separate from each other, and a making resistance contact having a fixed making resistance contact fixed to a conductive support member and a movable making resistance contact supported by the second arc electrode;
the making and breaking method of a gas blast circuit breaker with a making resistance contact is characterized in that:
at the time of making, when the first arc electrode and the second arc electrode are driven by the drive device and contact with each other, current flows from the second arc electrode to a making resistive element, and then when the movable making resistance contact contacts with the fixed making resistance contact, current flows from the second arc electrode to the conductive support member via the making resistance contact; and
at the time of breaking, when the first arc electrode and the second arc electrode are driven by the drive device and are separated, arc current which is generated at this time is flown to the conductive support member via the making resistance contact, and then the movable making resistance contact is separated from the fixed making resistance contact.

6. The gas blast circuit breaker with a making resistance contact as recited in claim 2, wherein:
the drive device has a link mechanism to make the second movable electrode to be moved in the direction reverse to the movement of the first movable electrode by an operating rod.

7. The gas blast circuit breaker with a making resistance contact as recited in claim 2, wherein:
the drive device has a grooved cam mechanism to make the second movable electrode to be moved in the direction reverse to the movement of the first movable electrode by an operating rod.
